(19) United States
(12) Patent Application Publication
(10) Pub. No.: US 2010/0049962 A1
(43) Pub. Date: Feb. 25, 2010

(54) METHOD FOR LOADING AND UPDATING CENTRAL PROCESSING UNIT MICROCODE INTO BASIC INPUT/OUTPUT SYSTEM

(75) Inventor: Lan-Cheng Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/542,690

(22) Filed: Aug. 17, 2009

(30) Foreign Application Priority Data
Aug. 25, 2008 (TW) 97132428

(51) Int. Cl. G06F 9/00

(52) U.S. Cl. 713/2

(57) ABSTRACT

The present invention relates to a method for loading a central processing unit microcode into a basic input/output system and a method for updating the central processing unit microcode of the basic input/output system. A system management interrupt instruction is applied to inform the basic input/output system an address and a length of the central processing unit microcode. Then, the basic input/output system performs an interrupt instruction to load the central processing unit microcode to a specific block of the basic input/output system.

### CROSS-REFERENCE TO RELATED APPLICATION

This application claims the priority benefit of Taiwan application serial no. 97132428, filed on Aug. 25, 2008. The entirety of the above-mentioned patent application is hereby incorporated by reference herein and made a part of specification.

### BACKGROUND OF THE INVENTION

1. Field of the Invention

The present invention relates to a basis input/output system (BIOS), especially a method for updating a central processing unit (CPU) microcode into the BIOS.

2. Description of Related Art

Currently, in order to be compatible with various hardware devices on a motherboard, a BIOS comprises program codes of a plurality of sections. For example, CPU microcode, program codes of peripheral devices or logo pictures. However, after the motherboard is used for a period of time, due to reasons of update of the hardware devices or better firmware developed by manufacturers, a part of the program codes in the BIOS need to be updated.

When a user updates the BIOS, an image file comprising the complete program codes in the BIOS is downloaded, and a utility is executed. The utility erases a memory originally storing the BIOS, and loads the image file into the memory originally storing the BIOS.

An above method has a hidden risk in that if program codes in the updated BIOS are incompatible with the hardware devices on the motherboard, the computer cannot be started up. For example, if the CPU microcodes in the BIOS are incompatible with a CPU on the motherboard (the CPU microcodes do not support the CPU on the motherboard), during a process of starting up, since the CPU cannot correctly load correct program codes, the process of starting up is interrupted, and it is displayed that the CPU microcode cannot be loaded.

### SUMMARY OF THE INVENTION

The present invention provides a method for loading a CPU microcode into a BIOS. By using a system management interrupt (SMI) instruction, the correct CPU microcode is loaded into the BIOS.

The present invention provides a method for updating the CPU microcode in the BIOS, which is used to load the correct CPU microcode when the CPU microcode cannot be correctly loaded.

The present invention provides a method for loading the CPU microcode into the BIOS. First, an SMI instruction is received through the BIOS. The SMI instruction comprises an address and a length of the CPU microcode. Next, an interrupt instruction is executed by the BIOS. According to the address and the length of the CPU microcode in the SMI instruction, the CPU microcode is loaded into a specific block of the BIOS.

The present invention provides a method for updating the CPU microcode in the BIOS. First, an SMI instruction is received through the BIOS. The SMI instruction comprises an address and a length of the CPU microcode. Next, whether a size of a specific block of the BIOS is larger than or equal to the length of the CPU microcode is judged. When the size of the specific block of the BIOS is greater than or equal to the length of the CPU microcode, an interrupt instruction is executed by the BIOS, and the CPU microcode is loaded to the specific block of the BIOS according to the address and the length of the CPU microcode.

Since the present invention adopts using an SMI instruction, the BIOS is informed of the address and the length of the CPU microcode, so that the BIOS loads the correct CPU microcode loaded into the address to a specific block, simultaneously resolving a problem in which a wrong CPU microcode causes a computer unable to load the CPU microcode.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart showing a method for loading a CPU microcode into a BIOS according to an embodiment of the present invention.

FIG. 2 is a flowchart showing a method for updating a CPU microcode in a BIOS according to another embodiment of the present invention.

FIG. 3 is a flowchart showing steps of starting up a computer system according to still another embodiment of the present invention.

### DESCRIPTION OF EMBODIMENTS

In prior art, if a CPU microcode is incompatible to a CPU on a motherboard, a computer system cannot be started up to an operating system, an error message is displayed and the computer system is stopped. The present invention provides a method for communicating a BIOS to a utility and loading the CPU microcode, so that the correct CPU microcode is loaded into the BIOS.

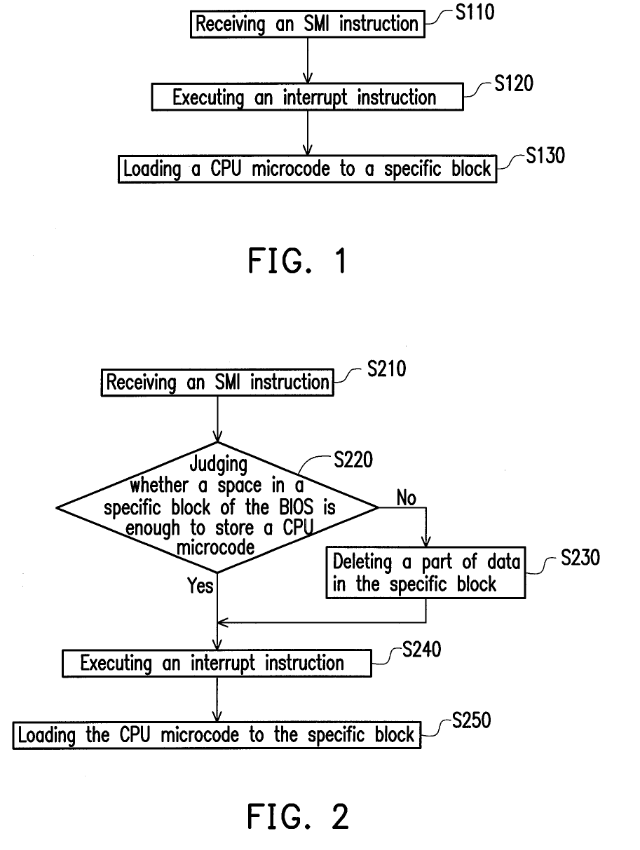

FIG. 1 is a flowchart showing a method for loading a CPU microcode into a BIOS according to an embodiment of the present invention. Referring to FIG. 1, first, in a step S110, the BIOS receives an SMI instruction. The SMI instruction may be sent from a utility, and the SMI instruction comprises an address and a length of a CPU microcode. The address indicated by the SMI instruction stores the correct CPU microcode.

Next, the BIOS receives the SMI instruction to obtain the correct CPU microcode in the meantime through the SMI instruction, and executes a interrupt instruction, referring to a step S120. The interrupt instruction may be a special INT 16 instruction or other loading instructions in current computer technology.

Then, in the load interrupt instruction, according to the address and the length of the CPU microcode indicated by the SMI instruction, the BIOS loads the CPU microcode in the address instructed by the SMI instruction from the memory reported by the utility to a specific block of the BIOS. According to the present embodiment, original program codes of the BIOS may be stored in a non-volatile memory on the motherboard, and the specific block may be dispose on a part of blocks of the non-volatile memory originally storing the BIOS or on other non-volatile memories on other positions on the motherboard.

In addition, the present invention may also be applied to updating the CPU microcode in the BIOS without refreshing the whole BIOS. The following provides another embodiment of the present invention. FIG. 2 is a flowchart showing a method for updating a CPU microcode in a BIOS according to another embodiment of the present invention. Referring to FIG. 2, first, in a step S210, the BIOS receives an SMI instruction. The SMI instruction is used to instruct the BIOS to update the CPU microcode, and comprises an address and a length of a CPU microcode. The address indicated by the SMI instruction stores the correct CPU microcode.

Next, after the BIOS receives the SMI instruction, the BIOS judges whether a space in a specific block is enough to store the CPU microcode indicated in the SMI instruction, referring to a step S220. According to the present embodiment, the specific block is a block used to store the CPU microcode. In the step S220, if the BIOS judges that the space in the specific block is not enough to store the CPU microcode, the BIOS deletes a part of data in the specific block, referring to a step S230, and continues to a step S240.

According to the present embodiment, since the specific block may already store other program codes, the remaining space in the specific block may not be enough to store the CPU microcode. The above step S230 may be displaying a message to inform a user that the remaining space in the specific block is not enough and to inform the user to selectively delete unnecessary program codes. In addition, the above step S230 may also be using the BIOS to determine program codes unrelated to present hardware devices, and deleting the unnecessary program codes automatically.

Oppositely, if in the step S220, the BIOS judges that the space in the specific block is enough to store the CPU microcode, the step S240 is then performed. In the step S240, the BIOS receives the SMI instruction, knows to load the correct CPU microcode in the meantime through the SMI instruction, and executes a interrupt instruction. In the interrupt instruction, according to the address and the length of the CPU microcode indicated by the SMI instruction, the BIOS loads the CPU microcode in the address to the specific block of the BIOS, referring to step S250. According to the present embodiment, the steps S240 and S250 are similar to the steps S120 and S130 according to the embodiment of FIG. 1; repeated description is thereby omitted.

It can be known from the previous embodiment that the present invention uses the SMI instruction and the interrupt instruction so that the specific block of the BIOS stores the correct CPU microcode. Therefore, during starting up of a computer system, the BIOS loads the correct CPU microcode from the specific block so that the computer system is started up properly and enters normal operation. In order to make persons having ordinary skills in the art able to implement the present inventions through teachings of embodiments, the following provides still another embodiment to illustrate a flowchart of starting up of the present invention.

In order to conveniently illustrate the present embodiment, before illustrating the present embodiment, a few presumptions are made. First, presume that the present embodiment is applied to situations in which a computer system is started up or restarted up from sleep. Next, presume that during processes of starting up or restarting up the computer system, the processes are controlled by a utility. Last, presume that program codes of a BIOS are stored in a non-volatile memory.

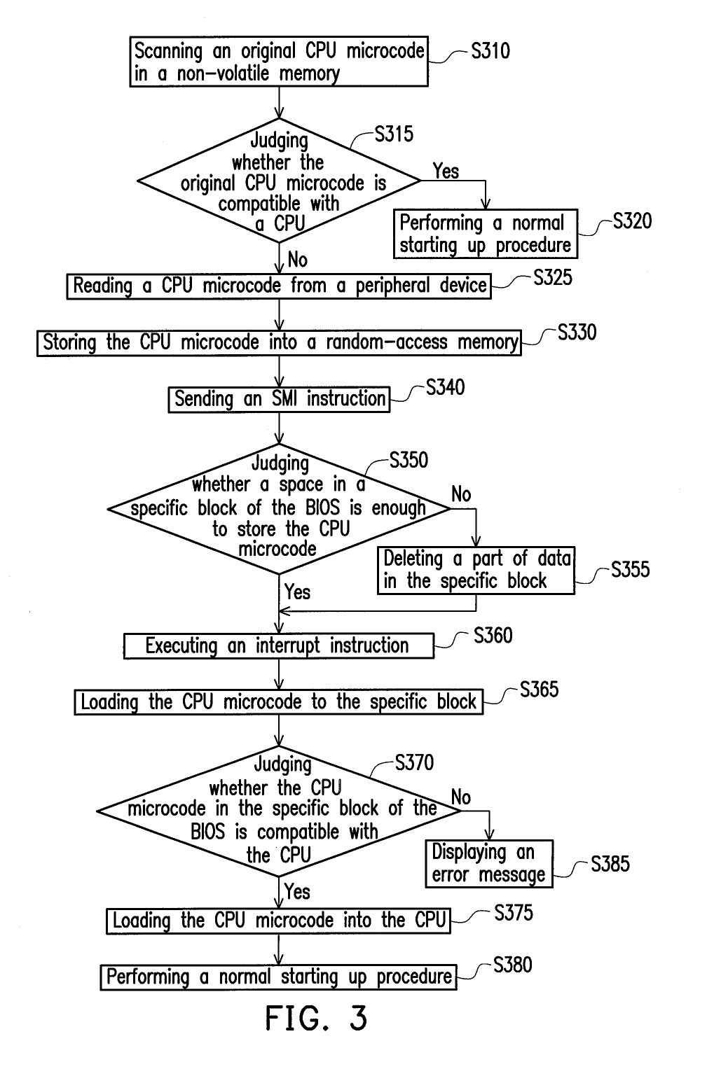

FIG. 3 is a flowchart showing steps of starting up a computer system according to still another embodiment of the present invention. Referring to FIG. 3, first, when the computer system is started up, the BIOS scans the program codes of each sections of the non-volatile memory, referring to a step S310, to obtain an original CPU microcode stored in the non-volatile memory and to judge whether the original CPU microcode in the non-volatile memory is compatible to a CPU on a motherboard, referring to a step S315, in other words, to judge whether the original CPU microcode supports the CPU on the motherboard. When the CPU microcode is compatible to the CPU on the motherboard, the computer system enters a normal process of starting up, referring to a step S320.

On the other hand, when the original CPU is incompatible with the CPU on the motherboard (meaning that the original CPU microcode cannot support the CPU on the mother board), the utility inquires whether to read a correct CPU microcode from a peripheral device of the computer system, referring to a step S325. According to the present embodiment, the above peripheral device may be a hard disc, a universal serial bus (USB) device, a floppy disc driver or an optical disc drive. In addition, in the above step S325, the utility could be unable to obtain information of which peripheral device and an actual storing address the correct CPU microcode is stored in. Hence, the computer system may display a message to inform a user to input the address in which the correct CPU microcode is stored. In addition, according to the present embodiment, the correct CPU microcode may be stored in the peripheral device beforehand, and set a path for the correct CPU microcode in the utility in advance, so that the utility reads the correct CPU microcode in the above step S325.

After the step S325, the CPU microcode read by the utility is stored in a random-access memory (RAM), referring to a step S330. Next, the utility sends an SMI instruction to the BIOS, referring to a step S340, to instruct the BIOS to update the CPU microcode. The SMI instruction sent from the utility comprises the address of the CPU microcode (which is the address in the RAM in which the utility stores the CPU microcode) and a length of the CPU microcode.

After the BIOS receives the SMI instruction, the BIOS judges whether a space in a specific block is enough to store the CPU microcode indicated in the SMI instruction, referring to a step S350. According to the present embodiment, the specific block is a block used to store the CPU microcode. In the step S350, if the BIOS judges that the space in the specific block is not enough to store the CPU microcode, the BIOS deletes a part of data in the specific block, referring to a step S355, and continues to a step S360. According to the present embodiment, since the specific block may already store other program codes, the remaining space of the specific block may not be enough to store the CPU microcode. The above step S355 may be displaying a message to inform a user that the remaining space in the specific block is not enough and to inform the user to selectively delete unnecessary program codes. In addition, the above step S355 may also be using the BIOS to determine program codes unrelated to present hardware devices, and deleting the unnecessary program codes automatically.

Oppositely, if in the step S350, the BIOS judges that the space in the specific block is enough to store the CPU microcode, the step S360 is then performed. In the step S360, since in the meantime the BIOS has received the SMI instruction and known the correct CPU microcode required to be loaded from the SMI instruction, the BIOS executes a interrupt instruction, in which the interrupt instruction may be a special INT 16 instruction or other instructions in current computer technology.

Next, in the interrupt instruction, according to the address and the length of the CPU microcode indicated by the SMI instruction, the BIOS loads the CPU microcode in the address to the specific block in the BIOS, referring to a step S365. According to the present embodiment, the original program codes of the BIOS may be stored in a non-volatile memory on the motherboard, and the specific block may be disposed on a part of blocks of the non-volatile memory originally storing the BIOS. In current BIOS technology, the non-volatile memory storing the BIOS may be sectioned into a plurality of blocks, and the BIOS has a descriptor table used to record a position of each of the blocks in the non-volatile memory. The specific block according to the present embodiment may be obtained by mapping out a protecting block in the descriptor table and recording a position of the protecting block in the descriptor table.

Last, after loading the CPU microcode to the specific block, the BIOS judges whether the CPU microcode is compatible with the CPU on the motherboard, referring to a step S370. If the CPU microcode is compatible with the CPU on the motherboard, the CPU microcode in the specific block is loaded into the CPU, referring to a step S375, and a normal process of starting up, referring to a step S380, is then performed. On the other hand, if the CPU microcode is judged to be incompatible with the CPU on the motherboard, the computer system displays an error message, referring to a step S385.

Since according to the above embodiment, the specific block already stores the correct CPU microcode, when the computer system is started up or restarted up from sleep, the correct CPU microcode is loaded from the specific block into the CPU, so that problems of the original CPU microcode being incompatible with the CPU on the motherboard are solved.

According to the above three embodiments, although loading the CPU microcode is used as an example, persons having ordinary skill in the art should know that the present invention may apply to loading or updating other kinds of programs codes in a BIOS.

In summary, since the present invention adopts using an SMI instruction, the BIOS is informed of the address and length of the CPU microcode, so that the BIOS loads the correct CPU microcode loaded in the address to a specific block, simultaneously resolving a problem in which a wrong CPU microcode causes a computer unable to load the CPU microcode.

Although the present invention has been described with reference to the above embodiments, application of the present invention is not limited to these embodiments. It will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for loading a central processing unit (CPU) microcode into a basic input/output system (BIOS), comprising:
receiving a system management interrupt (SMI) instruction through the BIOS, the SMI instruction comprising an address and a length of the CPU microcode;
executing an interrupt instruction by the BIOS; and
according to the address and the length of the CPU microcode, loading the CPU microcode into a specific block of the BIOS.

2. The method for loading the CPU microcode into the BIOS of claim 1, before executing the interrupt instruction, further comprising:
judging whether a size of the specific block is larger than or equal to the length of the CPU microcode; when a judgment is negative, deleting a part of data in the specific block and executing the interrupt instruction again; when the judgment is positive, directly executing the interrupt instruction.

3. The method for loading the CPU microcode into the BIOS of claim 1, before receiving the SMI instruction, further comprising:
reading the CPU microcode from a peripheral device; and
loading the CPU microcode into a random-access memory,
wherein the SMI instruction comprises an address of the CPU microcode in the random-access memory.

4. The method for loading the CPU microcode into the BIOS of claim 3, being applied to a computer system wherein the BIOS is stored in a non-volatile memory, and before reading the CPU microcode from the peripheral device, further comprising:
scanning a block of the non-volatile memory storing an original CPU microcode; and
judging whether the original CPU microcode is compatible to a CPU in the computer system; if a judgment is negative, displaying a message to inform to input an address of the CPU microcode in the peripheral device.

5. The method for loading the CPU microcode into the BIOS of claim 1, wherein the BIOS is stored in a non-volatile memory, the specific block being a protecting block in the non-volatile memory.

6. The method for loading the CPU microcode into the BIOS of claim 5, wherein the BIOS comprises a description table used to define an address of the protecting block.

7. The method for loading the CPU microcode into the BIOS system of claim 1, wherein the interrupt instruction is a special INT 16 instruction.

8. The method for loading the CPU microcode into the BIOS system of claim 1, being applied to a computer system, after the CPU microcode is loaded to the specific block, further comprising:
judging whether the CPU microcode in the specific block is compatible to a CPU in the computer system; if a judgment is negative, displaying an error message; if the judgment is positive, loading the CPU microcode in the specific block into the CPU in the computer system.

9. A method for updating a CPU microcode in a BIOS, comprising:
receiving an SMI instruction through the BIOS, the SMI instruction comprising an address and a size of the CPU microcode;
judging whether a size of a specific block of the BIOS is larger than or equal to a length of the CPU microcode;
when the size of the specific block of the BIOS is larger than or equal to the length of the CPU microcode, executing an interrupt instruction by the BIOS; and
according to the address and the length of the CPU microcode, loading the CPU microcode into the specific block of the BIOS.

10. The method for updating the CPU microcode in the BIOS system of claim 9, before receiving the SMI instruction, further comprising:
reading the CPU microcode from a peripheral device; and
loading the CPU microcode into a random-access memory,
wherein the SMI instruction comprises the address of the CPU microcode in the random-access memory.

11. The method for updating the CPU microcode in the BIOS of claim 10, being applied to a computer system wherein the BIOS is stored in a non-volatile memory, and before reading the CPU microcode from the peripheral device, further comprising:
scanning a block in the non-volatile memory storing an original CPU microcode; and
judging whether the original CPU microcode is compatible to a CPU in the computer system; if a judgment is negative, displaying a message to inform to input the address of the CPU microcode in the peripheral device.

12. The method for updating the CPU microcode in the BIOS of claim 9, wherein the BIOS is stored in a non-volatile memory, the specific block being a protecting block in the non-volatile memory.

13. The method for updating the CPU microcode in the BIOS of claim 12, wherein the BIOS has a description table used to define an address of the protecting block.

14. The method for updating the CPU microcode in the BIOS system of claim 9, wherein the interrupt instruction is a special INT 16 instruction.

15. The method for updating the CPU microcode in the BIOS system of claim 9, being applied to a computer system, after the CPU microcode is loaded to the specific block, further comprising:
judging whether the CPU microcode in the specific block is compatible to a CPU in the computer system; if a judgment is negative, displaying an error message; if a judgment is positive, loading the CPU microcode in the specific block into the CPU in the computer system.
